(19) United States
(12) Patent Application Publication
(10) Pub. No.: US 2026/0133094 A1
(43) Pub. Date: May 14, 2026

(54) IMPROVED MONITORING METHOD FOR CONTINUOUS FLOW ENGINES AND CONTINUOUS DEVICES AND MONITORING DEVICE TO REALIZE SUCH METHOD

(71) Applicant: Siemens Energy Global GmbH & Co. KG, München (DE)

(72) Inventors: Michel Tokic, Tettnang (DE); Anja von Beuningen, Erfurt (DE); Martin Bischoff, Aying, Großhelfendorf (DE); Jan Weustink, Karlsruhe (DE); Stefan Bohr, Zirndorf (DE)

(21) Appl. No.: 19/117,123

(22) PCT Filed: Sep. 7, 2023
(86) PCT No.: PCT/EP2023/074578

§ 371 Date: Mar. 31, 2025

(30) Foreign Application Priority Data
Oct. 7, 2022 (GB) 2214727.6

(51) Int. Cl. G01M 15/14; G06N 3/044

(52) U.S. Cl. CPC G01M 15/14; G06N 3/044

(57) ABSTRACT

The present method refers to a improved method of monitoring complex devices being utilized in long term applications and generating a bulk of data resulting from a plurality of data streams rendering handling such data being a difficult and demanding task. The method is configured to support a person tasked with interacting, monitoring and controlling complex devices not only providing an improved efficiency, but also improved security. Furthermore, the present invention refers to a corresponding monitoring device, an upgrade kit, a computer program product and a storage device containing such computer program product.

### BACKGROUND

The present method refers to a method of monitoring a continuously data generating device like a continuous flow engine. Furthermore, the present invention refers to a monitoring device adapted to realize an inventive method. Additionally, the present invention refers to an upgrade kit containing an inventive monitoring device. Furthermore, the present invention refers to a computer program product including instructions operable to cause a computing entity to execute an inventive method. Additionally, the present invention refers to a storage device for providing an inventive computer program product.

The industrial sector utilizes a plurality of devices. Many to most of the devices are utilized batchwise. However, in many industrial fields devices operate continuously essentially represent the backbone the corresponding industrial field depends upon. Compared to the batchwise utilized devices such continuously utilized devices providing an uninterrupted operation over months and longer provide different possibilities and challenges. A batchwise utilized device can be, for example, checked and restarted again and again. However, such continuously operated devices do not allow to simply be turned off without good reason. The continuous operation typically results in a plurality of data and experience acquired over years and decades. Allowing the skilled person working with such device to early detect minor changes to predict problems and correctly react to the specific needs at a certain point of time. Yet, upgrades and a more specific adaption according to the very specific needs and application result in constant changes making it hard for even experienced skilled persons to keep up to date. Leaving alone the subsequent generation of experts being confronted with an overwhelming amount of collected data and, for example, the task to correctly judge whether some historic data is relevant or not for the specific application. Taking not only into account the specific historic data, but also the maintenances and upgrades done in the meantime.

For example, continuous flow engines are very important and highly sophisticated devices utilized in modern industry. They are utilized in a plurality of applications and fulfill their tasks over years and decades. Being subject to maintenance and upgrades, but essentially remain the same. While the control of such continuous flow engines is naturally well developed, they are constantly evolving with even increased speed today. New available possibilities like additive manufacturing enabling to provide specifically tailored components in low numbers efficiently provide the possibility and challenge to even more adapt such continuous flow engines to the very specific application. Allowing to constantly improve the benefit obtained herewith. However, simultaneously confronting the persons working with such continuous flow engine to solve the above-described challenges. Either resulting in an increased risk of damages or dangers or a more restrictive utilization rendering the possible benefit of, for example, upgrades to be quite limited or worst case even lowering the output of such devices below the pre-upgrade values.

The field of power generation and distribution is a known example of conservative device handling, as reliability and security are top targets to be secured.

For example, the circuit breakers and electric grids utilized in such field are essentially constantly operating. Typically, no replacement is available or some local solution to reroute some electricity or utilize some movable solution is only available for short time and providing such means typically requires extensive time and effort to prepare so.

Identifying a problem in time to include it in some scheduled yearly maintenance or the like is a demanding task. And whether some deviation from the typical behavior can be ignored, might possibly be resulting from a past upgrade of some device within a managed electrical grid, or requires some immediate action to safely turn off the device before a grave danger for people is occurring.

This and further problems are solved by the products and methods as disclosed hereafter and in the claims. It was noted that the above referenced problems are especially emphasized in the energy production related industry and the utilization of continuous flow engines, naturally especially including the utilization of continuous flow engines in the field of energy production. Such applications can be surprisingly well supported by the solution as specified hereafter. Further beneficial embodiments are disclosed in the dependent claims and the further description and figures. These benefits can be used to adapt the corresponding solution to specific needs or to solve additional problems.

### SUMMARY

According to one aspect the present invention refers to a method of monitoring an industrial plant containing at least one continuous flow engine providing a current state, a power plant containing at least one continuous device providing a current state or a power distribution facility containing at least one continuous device providing a current state, wherein the method utilizes a monitoring device and a first user interface, wherein the monitoring device contains an artificial intelligence, wherein the artificial intelligence utilizes historic data, simulation data and interaction data, wherein the historic data represents data collected during use of the at least one continuous flow engine or a comparable continuous flow engine or the at least one continuous device or a comparable continuous device and the historic data and is stored in a historic database, wherein simulation data represents data acquired by running models of the physical properties and/or behavior of the continuous flow engine on a processing unit and the simulation data and is stored in a simulation database, wherein the interaction data represents data acquired by monitoring an interaction between an operator monitoring a real continuous flow engine and/or a simulated continuous flow engine and the interaction data and is stored in an interaction database, wherein the method contains the steps of providing evaluation data related to the at least one continuous flow engine or the at least one continuous device to the first user interface, wherein the evaluation data contains at least one operating suggestions and reference data, wherein the at least one operating suggestion contains data regarding a feasible action the artificial intelligence suggests be implemented, wherein the reference data contains data regarding the reasoning why the artificial intelligence provides the at least one operating suggestion containing at least one reference to the historic data, the simulation data and/or the interaction data. It was surprisingly noted that including such data regarding the reasoning allows to significantly simplify the evaluation of such suggested action for person tasked with interacting with such device or skilled persons not experienced with the specific device. A practical application of utilizing artificial intelligences for such devices suffered from the problem of deciding whether a corresponding suggestion is to be followed or not. A plurality of options is available to provide additional information like simulation data of a possible outcome of such action or data regarding possible benefits that can be acquired herewith. However, putting such solution into practice showed that such apparently simple data to be forwarded along corresponding suggestions surprisingly shows a very beneficial improvement of such solution for a great number of typical application cases.

The term “power plant” as used herein refers to classical power producing facilities like power plants utilizing steam turbines and gas turbines as well as wind power-based power producing facilities and solar power based facilities.

The term “continuous device” as used herein refers to a device operating continuously for a prolonged period of time generating a continuous stream of data related to its operation. Such prolonged period is preferable at least one month, more preferred at least 3 months, even more preferred at least 1 year. Examples of such continuous devices are circuit breakers as used in power distribution, hydrolyzers as utilized to convert renewable energies into hydrogen, or turbines utilized in wind power-based power plants.

The term “continuous flow engine” as used herein refers to a device utilizing a continuous stream of a fluid like a gas or a liquid. Herein, such continuous flow engine typically provides a rotor located in the fluid and interacting with said fluid. Herein, such fluid can either be utilized to provide a rotational movement of the rotor being able to be transformed into, for example, electrical energy. Examples of such continuous flow engines are gas turbines and steam turbines. Alternatively, the rotor can actively be rotated allowing to, for example, compress the fluid. An example of such application is a compressor as utilized, for example, in oil refineries.

The phrase “comparable continuous flow engine” refers to a continuous flow engine providing comparable technical properties compared to the continuous flow engine in question. For example, it refers to other continuous flow engines of the same model series. Such same model series of continuous flow engines are well established based on the broad application of continuous flow engines in the art. Like the SGT-800 series of Siemens representing a model series of gas turbines being distributed in many countries and well established to provide a reliable backbone of the power generation.

The phrase “comparable continuous device” refers to a continuous device providing comparable technical properties compared to the continuous device in question. For example, it refers to other continuous devices of the same model series.

The term “current state” as used herein refers to the current state the corresponding device like the continuous flow engine is operating in. The term current state in this context comprises the operating state of such device as well as the operational data and state transitions. Typically, the current state especially contains the state transitions. In typical application cases the current state at least contains two, more preferred all three, of the aforementioned information operational data in this context refer to conditions like oil pressure, power output, cooling air temperature, or the like.

Herein, the databases can be located on a single server. However, the databases may be located at different locations. For example, it is typical to locate the operator database and the simulation database at different locations. While this requires additional effort it allows to make best use of the typically split expertise and processing power required as the simulation database is provided by a third party investing in extensive effort and processing power to provide such database for a big number of users. While the practical experience showed that the users utilizing such continuous flow engines typically are reluctant to share insight in their specific operation and want to keep this expertise internal. Resulting in such method of operation and providing correspondingly adapted monitoring devices being surprisingly beneficial.

The term “monitoring device” as used herein refers to a physical device containing at least one processing unit and a data storage. While it is possible to place the parts of such device at different locations inside the industrial plant, they all work together and are managed together.

According to a further aspect the present invention refers to a monitoring device adapted to realize an inventive method, wherein the monitoring device contains at least one data storage and at least one processing unit, wherein the at least one data storage contains the artificial intelligence.

According to a further aspect the present invention refers to an upgrade kit containing an inventive monitoring device, wherein the upgrade kit is adapted to replace a conventional monitoring device without an artificial intelligence. It was noted that the inventive monitoring device is very beneficially to be introduced into existing industrial plants containing continuous flow engines. Herein, it was noted that it is surprisingly easy to utilize such inventive monitoring device in different industrial plants. Especially, it was noted that typically a superficial retraining with, for example, simulated data and/or historic data allows to adapt the artificial intelligence enough to enable its utilization in even very different industrial plants.

According to a further aspect the present invention refers to a computer program product, tangibly embodied in a machine-readable storage medium, including instructions operable to cause a computing entity to execute an inventive method.

According to a further aspect the present invention refers to a storage device for providing an inventive computer program product, wherein the device stores the computer program product and/or provides the computer program product for further use.

### BRIEF DESCRIPTION OF THE DRAWINGS

To simplify understanding of the present invention it is referred to the detailed description hereafter and the figures attached as well as their description. Herein, the figures are to be understood being not limiting the scope of the present invention but disclosing preferred embodiments explaining the invention further.

FIG. 1 shows a scheme of a system utilized to realize the inventive method.

### DETAILED DESCRIPTION

Preferably, the embodiments hereafter contain, unless specified otherwise, at least one processor and/or data storage unit to implement the inventive method.

Unless specified otherwise terms like “calculate”, “process”, “determine”, “generate”, “configure”, “reconstruct” and comparable terms refer to actions and/or processes and/or steps modifying data and/or generating data and/or converting data, wherein the data are presented as physical variable or are available as such.

The term “data storage” or comparable terms as used herein, for example, refer to a temporary data storage like RAM (Random Access Memory) or long-term data storage like hard drives or data storage units like CDs, DVDs, USB sticks and the like. Such data storage can additionally include or be connected to a processing unit to allow a processing of the data stored on the data storage.

In the following the invention will be exemplarily refer to continuous flow engines like gas turbines. It was noted that the application of the invention in such area was especially beneficial. Corresponding continuous flow engines are, for example, typically utilized as base power providing units in a power generation and distribution network additionally having to handle the fluctuations resulting from the inhomogeneous power generation resulting from renewable energy.

According to one aspect the present invention refers to a method As described above.

Furthermore, it was noted that it is beneficial for typical applications to train the artificial intelligence with the corresponding data. According to further embodiments, the artificial intelligence system was trained with at least with training historic data, training simulation data and training interaction data, wherein the training historic data is data collected during use of the continuous flow engine or a comparable continuous flow engine and the training historic data is stored in a training historic database, wherein training simulation data is data acquired by running models of the physical properties and/or behavior of the continuous flow engine on a processing unit and the training simulation data is stored in a training simulation database, wherein the training interaction data is acquired by monitoring an interaction between an operator controlling a real continuous flow engine and/or a simulated continuous flow engine and the training interaction data is stored in an training interaction database. It was noted that utilizing accordingly trained artificial intelligences already provide a significantly improved starting point already being able to solve many problems for many applications that are able to be trained on the fly using locally available stored data supporting a generically trained artificial intelligence to solve the specific needs of a specific application.

According to further embodiments, the method contains the step of retraining the artificial intelligence, wherein the artificial intelligence is retrained during use of the at least one continuous flow engine or the at least one continuous device. It was noted that based on the additional data provided a person interacting with such continuous flow engine or continuous device is able to maintain the consistent and reliable work even in case the artificial intelligence is retrained resulting in, for example, different suggestions or a different ranking of provided suggestions. Even in case the retraining it executed during utilization of such device resulting in a spontaneous change it is possible to quite easily ensure a safe operation of the device. While the possibility to realize such retraining with little to no effort on demand allows to, for example, decrease downtimes and other breaks originating from a required awareness task to ensure that all persons interacting are available of such change and do not misinterpret a corresponding different output of a corresponding monitoring device.

According to further embodiments, the method contains the step of receiving feedback data from an operator regarding the evaluation data, wherein the feedback data is utilized to retrain the artificial intelligence, wherein the feedback data is utilized by the monitoring device to retrain the artificial intelligence during use of the at least one continuous flow engine or the at least one continuous device. Utilizing such improvement loop allows to very efficiently and easily improve an inventive monitoring device.

According to further embodiments, the method contains the step of receiving feedback data of an operator regarding the evaluation data, wherein the feedback data is utilized to positively or negatively reinforce future evaluation data. Herein, such reinforcing future evaluation data can be realized by retraining the artificial intelligence and/or adapting a subsequent processing process adapting the evaluation data. For example, such adaption of the evaluation data can be a change of probabilities provided along the suggestions or filtering the suggestion.

According to further embodiments, the artificial intelligence is a recurrent neural network. It was noted that corresponding artificial intelligences are typically especially useful for many applications. Resulting in an even further increased processing speed and reliability. Especially, it was noted that such artificial intelligence can very efficiently provide corresponding suggestions as well we generate the reference data to be forwarded along.

According to further embodiments, the monitoring device forwards the evaluation data to a second user interface. Typically, that the evaluation data forwarded to the second user interface differs from the evaluation data sent to the first user interface. For example, the evaluation data can be automatically split by the artificial intelligence into a first part being relevant for the active operation monitoring the at least one continuous flow engine or the at least one continuous device and a second part being relevant for the long-term monitoring and maintenance scheduling being relevant for a strategic operator. It was noted that the inventive method enables to automatically split the data generated by the artificial intelligence to serve different needs and directly forward the data accordingly. Further increasing the application cases and efficiency of the inventive method.

According to further embodiments, the method contains the step of receiving feedback data of an operator regarding the evaluation data, wherein the feedback data is stored to be eventually included in future evaluation data provided by the monitoring device. Typically, the feedback data contains explanation data, wherein the explanation data contains information why an operating suggestion is considered correct or incorrect. Storing such data allows to build a new historic database originating from the improved insight of the inventive method. Such new historic database was noted to provide a significantly improved quality compared to present historic databases allowing to even further improve future processes and increasing the possibilities of future evaluations.

According to further embodiments, the method contains the step of receiving feedback data of an operator regarding the evaluation data, wherein the monitoring device contains a second artificial intelligence, wherein the second artificial intelligence is adapted to process the feedback data and assign the feedback to future evaluation data. While it is possible to utilize the already available artificial intelligence it was noted that including such second artificial intelligence for this explicit task can further improve the processing of such feedback data.

According to further embodiments, the current state provides a failure related to the at least one continuous flow engine or the at least one continuous device, wherein the evaluation data contains causes for the failure. It was noted that in typical application cases it is possible to additionally include a related failure with a high reliability and relatively little effort like processing power required to realize such solution. Simultaneously, it was noted that the persons interacting with the corresponding complex devices are typically able to make good use of such data to further improve the subsequent actions. While the surprisingly quite limited effort required to realize such solution allows to integrate this solution typically without problem also as standard solution.

According to further embodiments, the evaluation data contains historic data related to the current state. It was noted that the operator reviewing the evaluation data can be surprisingly well supported by including such data in the evaluation data. The inventor found out that the artificial intelligence can very easily identify relevant historic data and directly include it. While the feedback of tests showed that including such data significantly simplified the work of an operator tasked with monitoring and controlling the industrial plant.

According to further embodiments, the artificial intelligence is adapted to provide predictive maintenance related evaluation data. It was noted that for typical application cases corresponding data can be very efficiently provided using the inventive method.

According to further embodiments, the method contains the step of receiving an implementation request from the first user interface, wherein the implementation request triggers the monitoring device to implement the feasible action in the industrial plant. A further development of the present invention does not only provide one or more suggestions of feasible actions, but also implements the corresponding action on demand. Thus, the person tasked with, for example, operating the complex device can simply select from the provided suggestions and trigger a corresponding action without additional effort.

According to further embodiments, the method contains the step of the monitoring device evaluating an operating suggestion with regard to its potential impact on a safety of operation of the at least one continuous flow engine or the at least one continuous device, wherein the monitoring device automatically implements an operating suggestion in case the evaluation of the operating suggestion is considered to not negatively impact the safety of the at least one continuous flow engine or the at least one continuous device. Including such evaluation renders it even possible to automate, for example, the operation of such complex device at least partially allowing to further decrease the required effort of a person interacting like operating such complex device.

According to further embodiments, the method contains the step of the artificial intelligence identifying a failure of the at least one continuous flow engine or the at least one continuous device, wherein the artificial intelligence includes data regarding the failure in the evaluation data, includes a solution for such failure in the evaluation data and/or accordingly labels events to be stored in a database.

According to further embodiments, the method contains the step of storing a copy of the artificial intelligence, wherein the method contains the step of the monitoring device replacing the artificial intelligence being active with the artificial intelligence being stored based on a malfunction of the artificial intelligence being active and/or when receiving a replacement signal from the first user interface. It was surprisingly easy to implement such option. Simultaneously, the possibility to easily replace an artificial intelligence with a safety copy of an earlier version very easily allows to immediately react in case the output of the artificial intelligence seems to provide less beneficial results. Also, after upgrades or significant maintenance actions it can be desired to fall back to such safety version to avoid an unsuitable optimized artificial intelligence suffering from being too optimized to a specific application.

According to further embodiments, the method contains the step of storing a copy of the artificial intelligence, wherein the method contains the step of retraining the artificial intelligence being stored while the artificial intelligence being active is actively monitoring the industrial plant. It was noted that such parallel retraining of the artificial intelligence is a very beneficial feature allowing to optimize the output of the monitoring device without even requiring to stop the at least one continuous flow engine or the at least one continuous device. The retraining may be based on simulated data. For example, such simulated data can be retrieved from a remote database. The possibility to roll out optimized simulation data from a third party like an expert for the continuous flow engines or continuous devices allows to make best use of such external expertise. Being especially useful for the inventive method utilizing an artificial intelligence being tasked with such highly sensitive matter like the monitoring and eventually even controlling a continuous flow engine like a gas turbine. Even minor problems easily add up to grave problems and dangers requiring especial care for such applications. While the inventive method allows to tailor the monitoring device for the very specific use and thereafter retrain the artificial intelligence according to new insights or even changes of the industrial plant influencing the work of the at least one continuous flow engine or the at least one continuous device.

According to further embodiments, the artificial intelligence of the monitoring device filters operation data of the industrial plant to be provided to a first user interface, wherein the first user interface is adapted to be monitored by an operator monitoring the at least one continuous flow engine or the at least one continuous device, wherein the monitoring device actively filters at least 50%, more preferred at least 70%, even more preferred at least 90%, of the data to be displayed on the first user interface. It was noted that the inventive method allows to even set such strict restriction without impairing the operation or safety of the complex device. Simultaneously, reducing the provided data that strictly allows an operator to reliable have attention and time available for monitoring additional complex devices or take over additional tasks. On the contrast a flexible system easily results in different devices being monitored requiring attention at the same time. Possibly resulting in grave damages.

The phrase “to filter operation data” refers to an assessment whether corresponding data is to be shown on the first user interface or not. The data filtered out can, for example, be not displayed on the first user interface or can be marked by graying it out or removing a highlighting indicating relevant data. While it is typically preferred to define a certain amount of data not to be filtered accordingly representing very essential core data the inventive method utilizing the monitoring device allows to surprisingly significantly cut down this number enabling the operator to concentrate on information being important at that time.

According to a further aspect the present invention refers to a monitoring device as specified above.

According to a further aspect the present invention refers to an upgrade kit as specified above.

According to a further aspect the present invention refers to a storage device as specified above.

The following detailed description of the FIGURE uses the FIGURE to discuss illustrative embodiments, which are not to be construed as restrictive, along with the features and further advantages thereof.

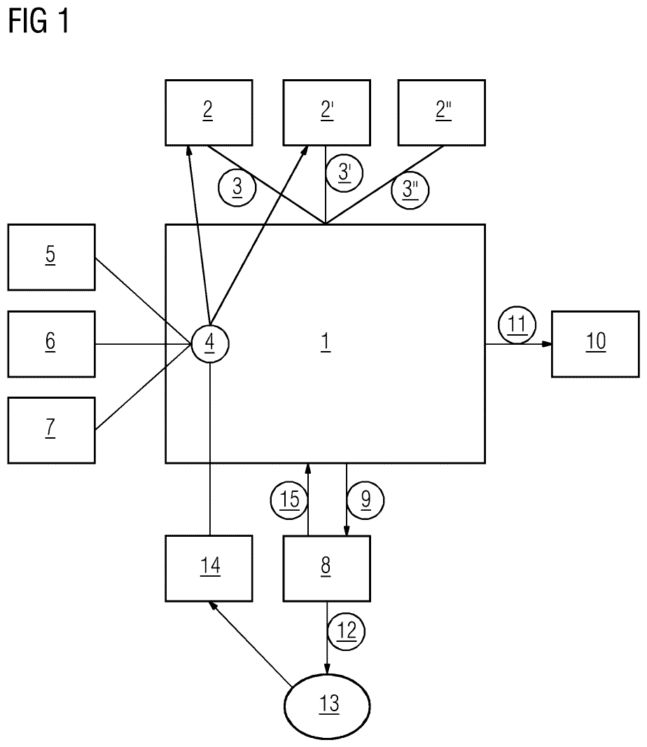

FIG. 1 shows a scheme of a system utilized to realize the inventive method. Said method is utilized to monitor three continuous flow engines. Said continuous flow engines 2, 2′, 2″ are in this case gas turbines utilized in a power plant to create electrical power. The three continuous flow engines 2, 2′, 2″ communicate with the monitoring device 1 containing the artificial intelligence 4 being a recurrent neural network in this case. Herein, current state data 3, 3′, 3″ regarding the current state received from the continuous flow engines 2, 2′, 2″ is constantly processed by the monitoring device 1. For said processing the artificial intelligence retrieves historic data from a historic database 5, simulation data from a simulation database 6 and interaction data form an interaction database 7.

The historic database 5 contains data collected over years of operation of the continuous flow engines 2, 2′, 2″ shown as well as further engines utilized in different power plants. Said data was collected during use of the continuous flow engines 2, 2′, 2″ or a comparable continuous flow engine. Containing normal operation as well as extreme situation and failure data that happened occur during such past time.

The simulation database 6 contains simulation data that was generated by means of running models of the physical properties and/or behavior of the continuous flow engine on a processing unit. Allowing to also gain insight into very extreme situation that should never occur in reality. For example, grave mistakes of operation by incorrect command options and the like. Also, it is possible to include situations like the failure of essential components possibly resulting in severe damages or even dangers to the person near the continuous flow engines 2, 2′, 2″.

The interaction database 7 contains interaction data regarding the interaction of the continuous flow engines 2, 2′, 2″ and persons working with them. For example, by means of monitoring an interaction between an operator monitoring a real continuous flow engine and/or a simulated continuous flow engine. Utilizing simulation data allows to gain further insight into the possible reactions of an experienced operator. And whether the reaction to be expected is good or bad. Maybe even detrimental to solve an occurring problem requiring a different reaction solution to be utilized.

The output of the artificial intelligence includes evaluation data 9 related to the three continuous flow engines 2, 2′, 2″ that is forwarded to the first user interface 8. Said evaluation data contains at least one operating suggestion contains data regarding a feasible action the artificial intelligence suggests being implemented. Furthermore, it contains reference data containing data regarding the reasoning why the artificial intelligence provides the at least one operating suggestion containing at least one reference to the historic data, the simulation data and/or the interaction data.

To allow to shorten the downtimes further and ensure the maximum possible adaption options the artificial intelligence 4 is adapted to be retrained during use of the three continuous flow engines 2, 2′, 2″. Allowing to correct not intended developments of the artificial intelligence as well as adapt the artificial intelligence to new needs arising from changes originating from maintenance and upgrades. For example, for such actions a copy of the artificial intelligence 4 can be stored. In case the described work of the monitoring device 1 as described herein becomes unstable, for example, the operator can trigger the copy to be utilized to replace the artificial intelligence with a prior version. Also, such copy of the artificial intelligence 4 can be running in parallel for a short time to get comparable evaluation data to allow to easily compare the change of the work of the artificial intelligence 4 before and after change. Being also surprisingly beneficial to evaluate the artificial intelligence 4 not after such retraining, but simply based on a continuous learning and developing process of the artificial intelligence 4 over time resulting in a possible slow deviation from the intended performance.

Furthermore, the monitoring device is adapted to utilize feedback data 12. An operator utilizing the first user interface 8 is able to enter feedback data 12. Said feedback data 12 is forwarded to a second artificial intelligence 13 processing the feedback data to make best use of it. Said second artificial intelligence constantly builds up a feedback database 14 containing high quality data resulting from it. Compared to feedback data stored in an unprocessed manner or the historic data of the historic database 5 the data contained in the feedback database 14 was noted to provide a significantly higher quality and reliability. Making such additional effort very worthwhile to further increase the possibilities and decision making in the future. Additionally, the feedback database 14 is also adapted to directly communicate with the artificial intelligence 4 allowing said artificial intelligence 4 to constantly further increase its evaluation data 9 with the time progressing and increasing feedback acquired. Herein, a positive or negative reinforcement of specific parts of the evaluation data takes place.

The operator utilizing the user interface 8 furthermore can select a suggested option from the evaluation data 9 simply by clicking a button. As the quality of the suggested actions is already very high and the operator has the increased insight based on the reference data provided such very swift possibility is enabled as longer decision processes are possible. While typically such option should only be possible for small operations overall posing no risk for the operation the present method allows to even suggest complex operation tasks summarizing a plurality of steps that can be evaluated easily as a whole to be utilized. Based on said selection an implementation request 15 is sent to the monitoring device 1 further processing the implementation request 15. Herein, the monitoring device can be adapted to directly realize the corresponding operation. In the present case the monitoring device 1 sends corresponding data to the control units of the three continuous flow engines 2, 2′, 2″. Said control unit are not shown in the FIGURE.

The monitoring device 1, however, does not only sent evaluation data to the first user interface 8. Additional evaluation data 11 is send to the second user interface 10. Herein, the additional evaluation data contains at least one operating evaluation and at least one operating suggestion and reference data, wherein the additional evaluation data differs from the evaluation data. In this context, the at least one operating suggestion contains data regarding a feasible action the artificial intelligence suggests being implemented and the at least one operating evaluation contains data regarding an assessment of a feasible operation and its outcome. The reference data contains data regarding the reasoning why the artificial intelligence provides the at least one operating suggestion containing at least one reference to the historic data, the simulation data and/or the interaction data. While the evaluation data sent to the first user interface 8 is directed to an operator operating the continuous flow engines 2, 2′, 2″ the additional evaluation data in this case is directed to a strategic member of the persons tasked with working with the continuous flow engines 2, 2′, 2″. For example, it relates to possible changes of the maintenance schedule or optimized operation increasing the overall benefit by changing the operating mode accordingly.

While most operating commands are to be triggered by an operator the artificial intelligence 4 is already adapted to further lessen the burden of the operator by taking over the safe decisions. In this context, the monitoring device 1 evaluates an operating suggestion with regard to its potential impact on a safety of operation of the three continuous flow engines 2, 2′, 2″. In Case the operating suggestion is considered to not negatively impacting the safety of the three continuous flow engines 2, 2′, 2″ the artificial intelligence 4 of the monitoring device 1 automatically implements an operating suggestion. Allowing to significantly lessen the burden on the operator. However, the operator is still able to review said decisions and eventually include a feedback data 12 to be processed accordingly resulting in the feedback database 14 to include that in comparable future cases the artificial intelligence 4 should not act on its own.

The present invention was only described in further detail for explanatory purposes. However, the invention is not to be understood being limited to these embodiments as they represent embodiments providing benefits to solve specific problems or fulfilling specific needs. The scope of the protection should be understood to be only limited by the claims attached.

1. A method of monitoring an industrial plant containing at least one continuous flow engine providing an current state, a power plant containing at least one continuous device providing a current state or a power distribution facility containing at least one continuous device providing a current state,
wherein the method utilizes a monitoring device and a first user interface,
wherein the monitoring device contains an artificial intelligence,
wherein the artificial intelligence utilizes historic data, simulation data and interaction data,
wherein the historic data represents data collected during use of the at least one continuous flow engine or a comparable continuous flow engine or the at least one continuous device or a comparable continuous device and the historic data and is stored in a historic database,
wherein simulation data represents data acquired by running models of physical properties and/or behavior of the continuous flow engine on a processing unit and the simulation data and is stored in a simulation database,
wherein the interaction data represents data acquired by monitoring an interaction between an operator monitoring a real continuous flow engine and/or a simulated continuous flow engine and the interaction data and is stored in an interaction database,
wherein the method contains the steps of providing evaluation data related to the at least one continuous flow engine or the at least one continuous device to the first user interface, wherein the evaluation data contains at least one operating suggestion and reference data,
wherein the at least one operating suggestion contains data regarding a feasible action the artificial intelligence suggests to be implemented,
wherein the reference data contains data regarding a reasoning why the artificial intelligence provides the at least one operating suggestion containing at least one reference to the historic data, the simulation data and/or the interaction data.

2. The method according to claim 1, wherein the method contains the step of retraining the artificial intelligence, preferably wherein the artificial intelligence is retrained during use of the at least one continuous flow engine or the at least one continuous device.

3. The method according to claim 1, wherein the method contains the step of receiving feedback data from an operator regarding the evaluation data, wherein the feedback data is utilized to retrain the artificial intelligence.

4. The method according to claim 1, wherein the method contains the step of receiving feedback data of an operator regarding the evaluation data, wherein the feedback data is utilized to positively or negatively reinforce future evaluation data.

5. The method according to claim 1, wherein the artificial intelligence is a recurrent neural network.

6. The method according to claim 1, wherein the monitoring device forwards the evaluation data or additional evaluation data to a second user interface,
wherein the additional evaluation data contains at least one operating evaluation and/or suggestion and reference data,
wherein the additional evaluation data differs from the evaluation data,
wherein the at least one operating suggestion contains data regarding a feasible action the artificial intelligence suggests to be implemented,
wherein the at least one operating evaluation contains data regarding an assessment of an feasible operation and its outcome,
wherein the reference data contains data regarding the reasoning why the artificial intelligence provides the at least one operating suggestion containing at least one reference to the historic data, the simulation data and/or the interaction data.

7. The method according to claim 1, wherein the method contains the step of receiving feedback data of an operator regarding the evaluation data, wherein the feedback data is stored to be eventually included in future evaluation data provided by the monitoring device.

8. The method according to claim 1, wherein the method contains the step of receiving feedback data of an operator regarding the evaluation data, wherein the monitoring device contains a second artificial intelligence,
wherein the second artificial intelligence is adapted to process the feedback data and assign the feedback to future evaluation data.

9. The method according to claim 1, wherein the artificial intelligence is adapted to provide predictive maintenance related evaluation data.

10. The method according to claim 1, wherein the method contains the step of receiving an implementation request from the first user interface, wherein the implementation request triggers the monitoring device to implement the feasible action in the industrial plant.

11. The method according to claim 1, wherein the method contains the step of the monitoring device evaluating an operating suggestion with regard to its potential impact on a safety of operation of the at least one continuous flow engine or the at least one continuous device, wherein the monitoring device automatically implements an operating suggestion in case the evaluation of the operating suggestion is considered to not negatively impact the safety of the at least one continuous flow engine.

12. The method according to claim 1, wherein the method contains the step of storing a copy of the artificial intelligence,
wherein the method contains the step of retraining the artificial intelligence being stored while the artificial intelligence being active is actively monitoring the industrial plant.

13. A monitoring device adapted to realize a method according to claim 1, wherein the monitoring device contains at least one data storage and at least one processing unit,
wherein the at least one data storage contains the artificial intelligence.

14. An upgrade kit containing a monitoring device according to claim 13, wherein the upgrade kit is adapted to replace a conventional monitoring device without an artificial intelligence.

15. A computer program product, tangibly embodied in a machine-readable storage medium, including instructions operable to cause a computing entity to execute a method according to claim 1.
